(19) United States
(12) Patent Application Publication
(10) Pub. No.: US 2008/0006690 A1
(43) Pub. Date: Jan. 10, 2008

(54) CREDIT CARDS AND RELATED SERVICES PROVIDED BY CREDIT CARD SERVICES ENTITIES THAT PROVIDE HEALTH REMINDERS UNRELATED TO CREDIT CARD FINANCIAL OR ACCOUNT INFORMATION

(76) Inventor: Ronald John Rosenberger, Newtown, PA (US)

Correspondence Address: Guy Kevin Townsend, 19 Sapphire Drive, West Windsor, NJ, 08550, US

(21) Appl. No.: 11/857,440

(22) Filed: Sep. 19, 2007

Related U.S. Application Data
(63) Continuation of application No. 09/634,612, filed on Aug. 5, 2000.
(60) Provisional application No. 60/192,669, filed on Mar. 28, 2000.

(51) Int. Cl. G06K 5/00; G06Q 40/00

(52) U.S. Cl. 235/380; 705/35

(57) ABSTRACT

The invention provides a credit card or credit card services provided by a credit card entity to a cardholder that provides at least one health reminder sent to or accessed by the cardholder of the credit card and related credit card customer services, wherein the health related information provided by the health reminder is not related to the financial or account information related to the use of the credit card.

### CROSS REFERENCE TO RELATED APPLICATIONS

This non-provisional patent application claims priority to, and consists of a subset of, U.S. non-provisional application Ser. No. 09/634,612, filed Aug. 5, 2000, which claims priority to U.S. provisional application 60/192,669, filed Mar. 28, 2000.

### BACKGROUND OF THE INVENTION

The credit card industry is one of intense competition. New products are introduced regularly in an attempt to increase (or at least maintain) market share. It is conceivable that card issuers could use additional services as part of the use of the credit card to attract users.

### SUMMARY OF THE INVENTION

The present invention provides credit card and credit card services that provide health reminders as additional services provided by the credit card provider, where the health reminder is not related to the financial services provided by the card issuer. Such additional services have the utility of making such credit cards more attractive to credit card users. Such credit cards or credit card services can provide health reminders, where the credit card entity provides cardholders with reminders, tips, or suggestions for any health related topic, health related preventive measure, medical check-up, medical exam, or medical procedure, including (but not limited to) monthly breast or testicular self-exam reminders; seasonal skin cancer prevention and screening reminders; annual mammogram, gynecological exam, prostate exam, or flu vaccination reminders; and reminders for less frequent procedures such as colorectal exams, bone density screenings, or even child immunizations. Reminders, tips, and suggestions may be gender specific (as in the above mentioned mammograms for women or the above mentioned prostate exams for men), or non-gender specific (as in the above mentioned colorectal exams which may apply to women or men). The scope of the health related reminders, tips and suggestions, also includes additional non-limiting examples such as dental check-ups, vision check-ups, diet and exercise programs, or pet health.

According to the present invention, the reminder, tip or suggestion would in no way have anything to do with the card matters at hand. The information presented by the credit card entity as a reminder, tip or suggestion is not intended to include things such as sales promotions that are related to the core business that a card issuer may represent. For example, receiving a reminder that a stiff late fee will be levied if the cardholder fails to make a timely payment would not have any bearing on this disclosure, while reminding somebody to get a dental checkup, being that a dental checkup reminder is in no way related to card matters, would have ramifications with regards to this disclosure.

According to the present invention, the terms, “credit card entity”, “card entity” and “card issuer” are deemed to be interchangeable. The aforementioned terms are herein defined to also include any and all credit card related entities that are able to put aspects of this disclosure into practice with regards to any cards that they offer (credit cards, “smart cards”, debit cards, etc.), such as credit card companies, credit card issuers, credit card co-branding partners, credit card affinity card partners, credit card manufacturers, credit card industry consultants, or entities that promote and offer card issuers' cards to the public in exchange for revenues from card issuers, and the like. Hereafter, the term “reminders” is also meant to encompass the terms “tips” and “suggestions”.

### DESCRIPTION OF DRAWINGS

FIG. 1—Shows an August “warning” reminder for a cardholder to have a mammogram and gynecological examination during the month of October, along with a reminder for the cardholder to perform a monthly breast-self examination. Also illustrated is a tip on where to find instructions on how to perform the breast self-examination. The reminder may be part of the actual card statement, may be sent as a separate item along with the card statement, or may be presented to the cardholder by any means such as mail, fax, e-mail, phone, smartcard reader, etc.

FIG. 2—Shows a September “warning” reminder for a cardholder to have a mammogram and gynecological examination during the month of October, along with a reminder for the cardholder to perform a monthly breast-self examination. Also illustrated is a tip on where to find instructions on how to perform the breast self-examination. The reminder may be part of the actual card statement, may be sent as a separate item along with the card statement, or may be presented to the cardholder by any means such as mail, fax, e-mail, phone, smartcard reader, etc.

FIG. 3—Shows the October reminder for a cardholder to have a mammogram and gynecological examination during the month of October, along with a reminder for the cardholder to perform a monthly breast-self examination. Also illustrated is a tip on where to find instructions on how to perform the breast self-examination. The reminder may be part of the actual card statement, may be sent as a separate item along with the card statement, or may be presented to the cardholder by any means such as mail, fax, e-mail, phone, smartcard reader, etc.

FIG. 4—Shows the November reminder for a cardholder that serves to either congratulate the cardholder on having the mammogram and gynecological examination performed during the month of October, or to remind the cardholder that it is not too late to get the procedures performed had she neglected to do so. Also, there is a reminder for the cardholder to perform a monthly breast-self examination. Also illustrated is a tip on where to find instructions on how to perform the breast self-examination. The reminder may be part of the actual card statement, may be sent as a separate item along with the card statement, or may be presented to the cardholder by any means such as mail, fax, e-mail, phone, smartcard reader, etc.

### DETAILED DESCRIPTION OF THE INVENTION

The present invention provides credit card and credit card services that provide health reminders as additional services provided by the credit card provider, where the health reminder is not related to the financial services provided by the card issuer. Such additional services have the utility of making such credit cards more attractive to credit card users. Such credit cards or credit card services provide health reminders, where the credit card entity provides cardholders with reminders, tips, or suggestions for any health related topic, health related preventive measures, medical check-up, medical exam, or medical procedure, including (but not limited to) monthly breast or testicular self-exam reminders; seasonal skin cancer prevention and screening reminders; annual mammogram, gynecological exam, prostate exam, or flu vaccination reminders; and reminders for less frequent procedures such as colorectal exams, bone density screenings, or even child immunizations. Reminders, tips, and suggestions may be gender specific (as in the above mentioned mammograms for women or the above mentioned prostate exams for men), or non-gender specific (as in the above mentioned colorectal exams which may apply to women or men). The scope of the health related reminders, tips and suggestions, also includes additional non-limiting examples such as dental check-ups, vision check-ups, diet and exercise programs, or pet health.

According to the present invention, the reminder, tip or suggestion would in no way have anything to do with the card matters at hand. The health reminder information presented by the credit card entity as a reminder, tip or suggestion is not intended to include things such as sales promotions that are related to the core business that a card issuer may represent. For example, receiving a reminder that a stiff late fee will be levied if the cardholder fails to make a timely payment would not have any bearing on this disclosure, while reminding somebody to get a dental checkup, being that a dental checkup reminder is in no way related to card matters, would have ramifications with regards to this disclosure.

The present invention provides, but is not limited to, where the credit card entity provides reminders, tips, and suggestions for any health related topic, health related preventive measure, medical check-up, medical exam, or medical procedure. A credit card entity may disseminate this information to the general public at large by offering seasonal or timely health related reminders through advertising or promotional literature as a public service; while this is novel in itself, it is envisioned that the preferred embodiment will take the form of reminders, tips and suggestions that will be provided to individual cardholders. Hereafter, the term “reminders” is also meant to encompass the terms “tips” and “suggestions”. For example, in the case of a breast self-exam reminder, the reminder may include a tip and/or suggestion regarding the best time of the month to perform the self-exam. An especially novel way for the credit card issuer to transmit the reminder to the cardholder is to combine the reminder with a credit card transaction/activity statement (hereafter known as the “card statement”). Embodiments of a credit card statement may take on any form, whether printed, online via a website, e-mail, smartcard reader, etc. A card statement is one of the few periodic pieces of communication that are consistently read by the people that receive them, so including an important, health related reminder on a card statement would be an excellent and novel way to transmit that reminder.

The reminder can optionally be detachable from the card statement via a perforation, or by any other means that allows for separation, so the reminder could be stored separately from the statement. This would allow the reminder to be referenced in a more convenient and/or visible location, without disclosing any aspect of financial or account information. Other embodiments would allow for a separate reminder to be part of the card statement enclosure, separate from the actual statement itself, also, the separate reminder may be presented independently of the card statement enclosure to the cardholder by any means such as mail, fax, e-mail, phone, smartcard reader, etc.

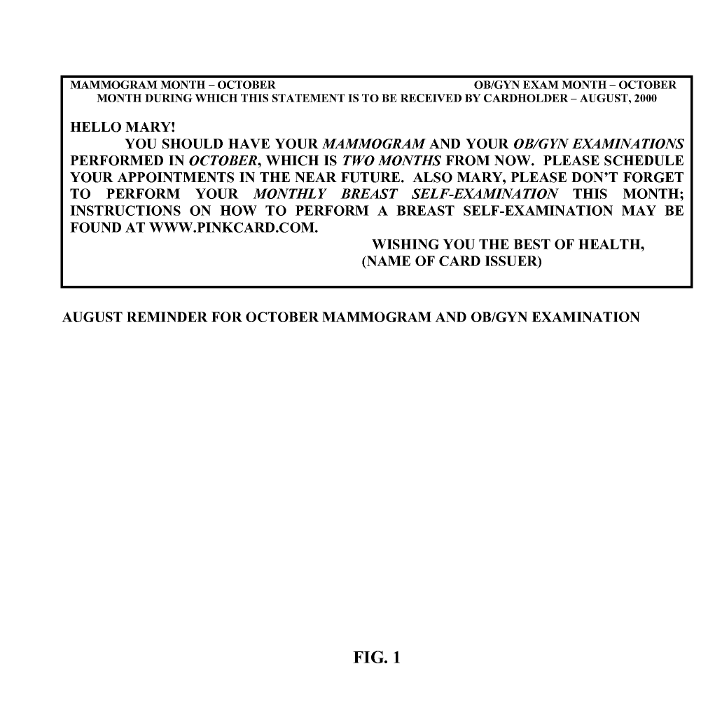

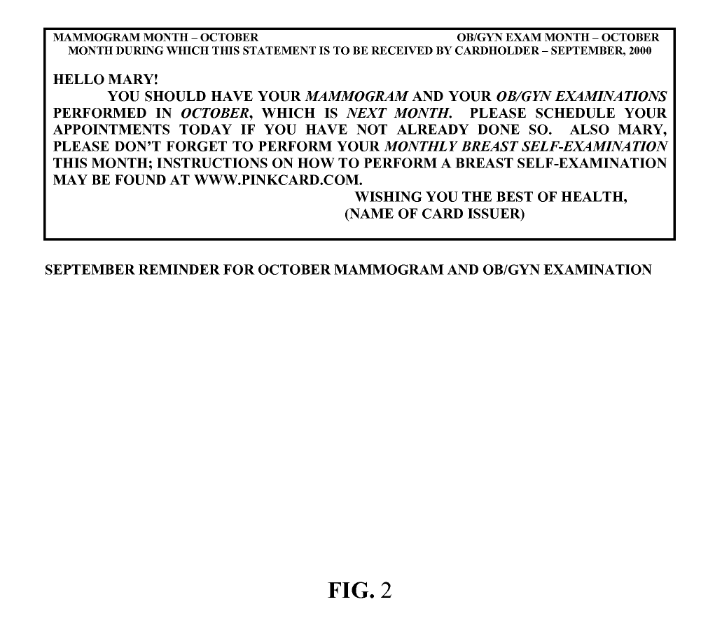

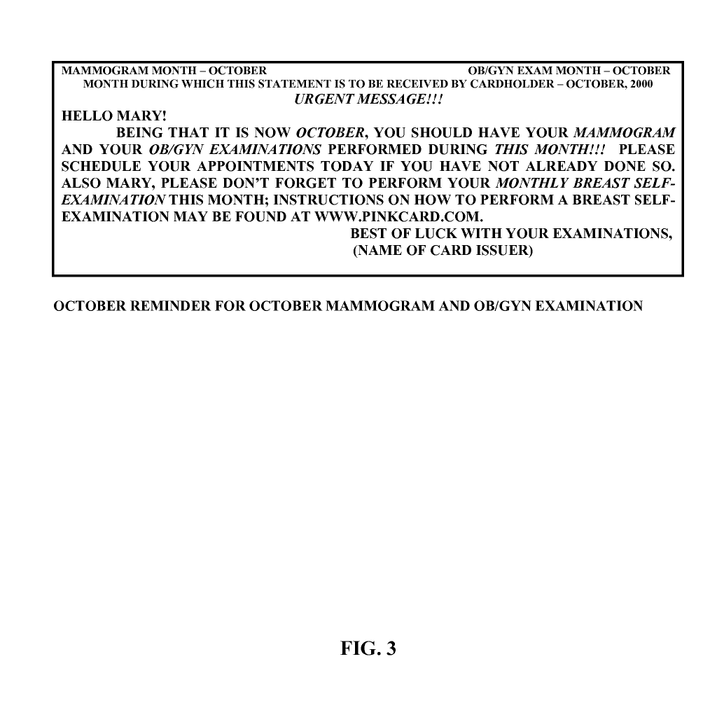

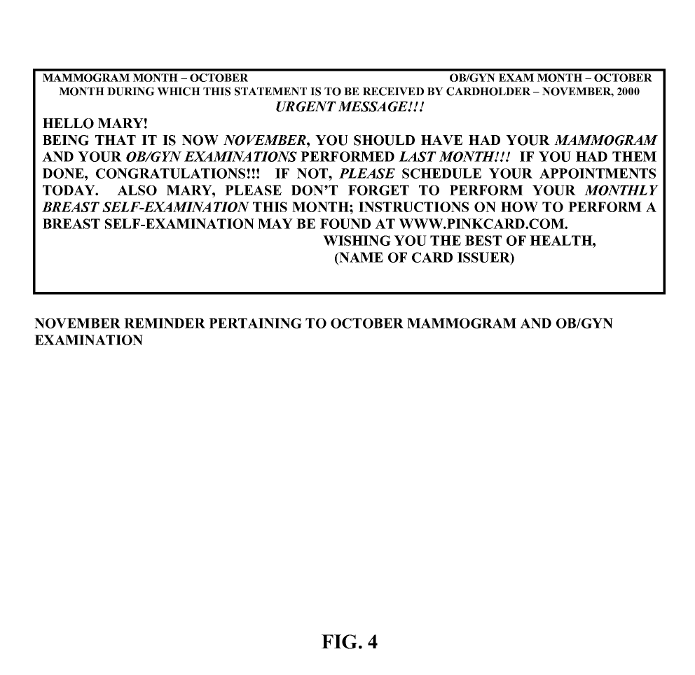

Let's look at the above feature in terms of the health reminder credit cards. In most instances, card statements are cut monthly. Coincidentally, certain self-exams are recommended on a monthly basis, but people don't always remember to do them. Take the instance of a woman's monthly breast self-exam. It is recommended that women give themselves a monthly breast examination to aid in the early detection of breast cancer. The health reminder card has a feature on a separate monthly reminder or reminder included with the card statement that includes an automatic reminder for women to give themselves a monthly breast self-exam, so women will hopefully perform breast self-exams more consistently. Starting at certain age milestones, women are advised to receive annual gynecological exams and annual mammograms. These potentially life saving early detection tools are ignored by millions of women for different reasons. Some women simply forget about them, or they lose track of time since their last exam. The health reminder card expects to use its system of health reminders to reduce the oversight on behalf of the cardholders, and hopes to help save lives in the process.

Whereas having monthly and annual reminders in relation with a card statement is a novel and useful feature, the concept may be extended to include other features that will further enhance the value of card offerings to the end user. One such feature as it pertains to the health reminder card is where women may select which month that their card statement will remind them that it is time for their annual mammogram and gynecological examinations. Hereafter, the term “examinations” will encompass both the terms “mammograms” and “gynecological (OB/GYN) examinations”. Traditionally, women have been told to have examinations around their birthday, because that would be easy for the woman to remember. How much fun is that? It's like associating one's birthday with a dreaded chore (It's my birthday—time to clean the bathroom!). A benefit of the health reminder card is that a woman may select when she wishes to have her examination reminders, and how soon before her examinations she wants to start receiving reminders. Say a woman wants to have her examinations in October. She figures in October there isn't a whole lot going on—no summer vacations or major family holidays, nor is there any ordinary calendar reminder that would make her think “mammogram and gynecological exam”. She may set up her statement to remind her that October is her examinations month. This may occur at the time of applying for the card, and may be subsequently revised as the woman sees fit. Although the mammogram reminder and OB/GYN examination reminder in the example shown are grouped together in October, the mammogram and OB/GYN examination may each have its own key month in which to be performed (example: mammogram in April, OB/GYN examination in August). Furthermore, the woman may specify how many months or billing cycles in advance she wants to start receiving “warning” reminders that her “examinations month” is forthcoming. Say the woman chooses to have her reminders begin two months prior to her examinations month. In August, the reminder could be “YOU SHOULD HAVE YOUR MAMMOGRAM AND YOUR OB/GYN EXAMINATIONS PERFORMED IN OCTOBER, WHICH IS TWO MONTHS FROM NOW. PLEASE SCHEDULE YOUR APPOINTMENTS IN THE NEAR FUTURE.” (FIG. 1). In September, it could be “YOU SHOULD HAVE YOUR MAMMOGRAM AND YOUR OB/GYN EXAMINATIONS PERFORMED IN OCTOBER, WHICH IS NEXT MONTH. PLEASE SCHEDULE YOUR APPOINTMENTS TODAY IF YOU HAVE NOT ALREADY DONE SO.” (FIG. 2). In October the confirmation reminder could read as “BEING THAT IT IS NOW OCTOBER, YOU SHOULD HAVE YOUR MAMMOGRAM AND YOUR OB/GYN EXAMINATIONS PERFORMED DURING THIS MONTH!!! PLEASE SCHEDULE YOUR APPOINTMENTS TODAY IF YOU HAVE NOT ALREADY DONE SO.” (FIG. 3). In November, a follow-up reminder could read as “BEING THAT IT IS NOW NOVEMBER, YOU SHOULD HAVE HAD YOUR MAMMOGRAM AND YOUR OB/GYN EXAMINATIONS PERFORMED LAST MONTH!!! IF YOU HAD THEM DONE, CONGRATULATIONS!!! IF NOT, PLEASE SCHEDULE YOUR APPOINTMENTS TODAY.” (FIG. 4). Note that in FIGS. 1 through 4, basic cardholder information (in this case, cardholder name information) is used in order to greet the cardholder in a personal and friendly fashion (“HELLO MARY!”). By allowing the woman the opportunity to express preferences concerning the reminders, tips, and suggestions that she receives, the resulting flexibility and versatility of the feature will be viewed as being especially valuable and useful. An extension of this is that if an individual supplies to the card issuer the contact information of a chosen health care professional, along with days and times the individual tends to be available, the credit card entity could actually make the appointment on behalf of the individual for any health appointment, examination or procedure (mammogram, etc.), with a confirmation via mail, fax, e-mail, phone, smartcard reader, etc. The information supplied by the individual would be subsequently revisable by the individual. The announcement may even appear in conjunction with the card statement (“You have an appointment with Dr. ABC on Thursday, October XX @ XX:XX pm for your mammogram. If you are unable to make the appointment, contact the doctor's office directly for an alternate date and time”).

The scope of this invention includes where the credit card entity provides cardholders with reminders, such as, but not limited to tips, or suggestions for any health related topic, health related preventive measure, medical check-up, medical exam, or medical procedure, including (but not limited to) monthly breast or testicular self-exam reminders; seasonal skin cancer prevention and screening reminders; annual mammogram, gynecological exam, prostate exam, or flu vaccination reminders; and reminders for less frequent procedures such as colorectal exams, bone density screenings, or even child immunizations. Reminders, tips, and suggestions may be gender specific (as in the above mentioned mammograms for women or the above mentioned prostate exams for men), or non-gender specific (as in the above mentioned colorectal exams which may apply to women or men). The scope of the health related reminders, tips and suggestions could even extend to things such as dental check-ups, vision check-ups, diet and exercise programs, or even pet health.

Many credit card entities give their cardholders incentives, whether air miles, free gas, etc. However, offerings could be aimed at providing for the welfare of the cardholders. There are potential opportunities for a card issuer to offer features, over and above what cardholders ordinarily expect, that could give a card issuer an advantage in the marketplace.

The first of these features is where a credit card entity provides comprehensive health related information. The limiting factor is that the information is health related. The card entity could supply information on any health related topic. For example, the card entity could provide ready information on how to perform a self-examination procedure such as a breast or testicular self-exam. Other information could include a directory of facilities offering procedures (such as mammograms), including information on where to get free or low cost procedures. Also, comprehensive information on the latest treatments for a given disease or affliction may be offered to a cardholder, or to any individual for that matter as a public service. Information may be conveyed to the end user by any means, whether it is person-to-person, hard copy form, e-mail, smartcard reader, website, internet links connecting a card website to a health related website that would contain the pertinent information, etc.

The abovementioned aspects of a credit card entity offering comprehensive health related information and health related mechanisms to assist individuals for cardholders is novel in light of what credit card entities and their related services currently offer.

### FURTHER EMBODIMENTS

The invention of credit card entities that providing cardholders with reminders, tips, and suggestions that appear directly on the card transaction/activity statement (where embodiments may take on any form, whether printed, online via a website, e-mail, smartcard reader, etc.), or where reminders, tips, and suggestions are included as a separate item in the card transaction/activity statement enclosure, or where the reminders, tips and suggestions may also be presented to the cardholder independently of the card transaction/activity statement by any means such as mail, fax, email, phone, smartcard reader, etc., has the ability to be expounded upon considerably.

In order to be fair to the invention, although specific examples have been presented, there are a multitude of additional subject matters that qualify as being within the range, scope, and spirit of this invention. This invention lends itself to anything that is a reminder, tip, and suggestion that is of a periodic nature, or that occur at a given milestone; whether the reminder, tip, and suggestion is for a periodic or one time health issues, such as medications, exams, evaluations, etc.

Using the terminology set forth above, health reminders can be provided as reminders, tips, and suggestions may optionally be provided in at least one of, but not limited to, three basic embodiments:
1. Health reminders, tips, and suggestions that are automatic, general, non cardholder-specific, and do not rely on basic cardholder information or cardholder preferences information.
2. Health reminders, tips, and suggestions that make use of basic cardholder information to tailor the reminder information to a given cardholders
3. Health reminders, tips, and suggestions that make use of cardholder preferences information to customize or tailor any or all aspects of reminder information, including (but not limited to) parameters, content, text, etc, where the end result reflects the preferences or desires of the cardholders

All three alternative or inclusive embodiments have been illustrated in the previous credit Card section. In accordance with number 1 above, the credit Card's breast self-examination reminder is automatic; every cardholder will receive the automatic breast self-examination reminder, including the unfortunate male souls that unwittingly become cardholders. Per number 3 above, the credit Card uses cardholder preferences information to customize or tailor parameters regarding the month or billing cycle that is desired for the culmination of the mammogram and/or OB/GYN examination reminders. Cardholder preferences information is also used in determining how many months or billing cycles in advanced a given cardholder wishes to begin receiving reminders prior to the mammogram and/or OB/GYN examination “months”. As it may be seen from the credit Card example, it is possible to use all three of the abovementioned embodiments in a single “set” of reminders, tips, or suggestions; although, as one may imagine, any of the disclosed embodiments may be used singularly or in multiples, and in any combination or permutation, for a given set of reminders, tips, and suggestions.

For illustration purposes, let us look at an example where a cardholder submits cardholder preferences information that will be used to customize or tailor numerous aspects of reminder information, such as parameters, content, and text, per the above embodiment #3. The example will feature both “theme” and “non-theme” related reminder items. Following thereafter will be the resulting reminder, with reminders, tips, and suggestions that not only shows the cardholder preferences information submitted by the cardholder (embodiment #3), but will also show features of embodiments #1 and #2, and will thus be labeled accordingly.

### File Maintenance for Your Personal Reminders

NUMBER OF MONTHS OR BILLING CYCLES IN ADVANCE THAT YOU WOULD LIKE TO HAVE REMINDERS APPEAR ON YOUR BILLING STATEMENT (minimum 2/maximum 12)—2

(Example: Selecting “2” will have January and February reminders appear on the transaction statement that you receive in January.

DISCLAIMER—While we the card issuer will do everything in our power to make sure that reminders are received in a timely and accurate fashion, the cardholder agrees as a condition of using this reminder feature to hold the card issuer harmless in the event that damages arise through the failure of the card issuer to remit reminders to the cardholder, regardless of reason or circumstance.

HEALTH REMINDERS

| | |
|---|---|
| Enter the number of the months you would like to be reminded to | 10 |
| have your mammogram and OB/GYN examination. Should you | |
| not enter a number, you will automatically receive the reminder | |
| during the month of your birthday. (Example: March = 3) | |
| Enter the total number of months notice that you would like to be | 3 |
| reminded of your mammogram and OB/GYN examination. Should | |
| you not enter a number, you will automatically receive two months | |
| notice. (Example: 3 months notice will remind you of your March | |
| mammogram and OB/GYN exam during the months of January, | |
| February, and March) | |
| Any health related reminders or appointments that you would like to | |
| be reminded of? Enter them below as you would like for them to | |
| appear on your reminders, and enter the number of the month that | |
| you would like to receive the reminder in the right hand column | |
| (Example: March = 3) | |
| Dentist appointment 9/17, 7 PM | 9 |

Here is the resulting list of reminders, tips, and suggestions, using September 2000 as the month of the statement that the reminders appear on, observing the two month or billing cycle parameter specified above that will show reminders for September and October.

For clarity's sake, the reminders that use cardholder preferences will be labeled regarding each reminder's theme, while other things that may appear will be labeled as either “theme” or “non-theme”; also, embodiments will also be referenced by number.
“Mary, don't forget that you should have your mammogram and your OB/GYN examinations performed in October, which is next month. Please schedule your appointments today if you have not already done so.
“Don't forget to perform your monthly breast self-examination this month”
“Dentist appointment 9/17, 7 PM

(Health “theme”; mammogram and OB/GYN reminder is embodiment #3 using cardholder preferences information; the breast self-examination reminder in this case is embodiment #1 in that it is an automatic message; however, if it was an automatic message tailored to the fact that the cardholder is female, it would be an embodiment #2 that used basic cardholder information to determine the gender of the cardholder; dentist appointment is embodiment #3 using cardholder preferences information).

As may be seen, the disclosed embodiments work quite well with each other when combined, and are capable of covering a great deal of range, especially when limitations regarding topicality are relaxed or removed.

A distinction must be made in that the information presented by the credit card entity as a reminder, tip or suggestion is not intended to include things such as sales promotions that are related to the core business that a card issuer may represent. Also, another distinction is that the reminder, tip or suggestion would in no way have anything to do with the card matters at hand. For example, receiving a reminder that a stiff late fee will be levied if the cardholder fails to make a timely payment would not have any bearing on this disclosure, while reminding somebody to get a dental checkup, being that a dental checkup reminder is in no way related to card matters, would have ramifications with regards to this disclosure.

Thus disclosed are cards and related services provided by credit card entities that target specific demographics of end users. Also presented are unique and novel features for cards and related services that lend themselves not only for the specifically targeted populations mentioned, but also for card users in general. The full range, scope, and spirit of the disclosure with regards to its potential embodiments will be apparent to those skilled in the art.

What is claimed is:

1. A credit card provided by a credit card entity to a cardholder that provides at least one health reminder sent to or accessed by said cardholder of said credit card and related credit card customer services, wherein the health related information provided by said health reminder is not related to the financial or account information related to the use of the credit card.

2. A credit card according to claim 1, wherein said credit card includes credit cards, smart cards, debit cards and similar cards.

3. A credit card according to claim 1, wherein said credit card entity is selected from credit card companies, credit card issuers, credit card co-branding partners, credit card affinity card partners, credit card manufacturers, credit card industry consultants, or entities that promote and offer card issuers' cards to the public in exchange for revenues from card issuers.

4. A credit card according to claim 1, wherein said health reminder is selected by the cardholder or by the credit card entity.

5. A credit card according to claim 1, wherein said health reminder provides reminders, tips, or suggestions for any health related topic, health related preventive measure, medical check-up, medical exam, or medical procedure.

6. A credit card according to claim 5, wherein said health reminder is selected from breast or testicular self-exam reminders; skin cancer prevention and screening reminders; mammogram, gynecological exam, prostate exam, vaccination reminders, colorectal exams, bone density screenings, or child immunizations.

7. A credit card according to claim 5, wherein said health reminder is selected from dental check-ups, vision check-ups, diet and exercise programs, or pet health.

8. A credit card according to claim 5, wherein said health reminder is gender specific or non-gender specific.

9. A credit card according to claim 1, wherein said health reminder is provided by mail, fax, e-mail, phone, smartcard reader or other means.

10. A credit card according to claim 1, wherein said health reminder comprises at least one reminder, tip, or suggestion that is selected from at least one of (a) automatic, general, or non cardholder-specific in nature, (b) customized or tailored to the cardholder relating to at least one aspect of the health reminder information, or (c) reflects the preferences or desires of the cardholder.

11. A credit card according to claim 1, wherein said health reminder further comprises disclaimers.

12. Credit card services provided by a credit card entity to a cardholder using said credit card that provides at least one health reminder sent to or accessed by said cardholder of said credit card services and related credit card customer services, wherein the health related information provided by said health reminder is not related to the financial or account information related to the use of the credit card.

13. Credit card services according to claim 12, wherein said credit card includes credit cards, smart cards, debit cards and similar cards.

14. Credit card services according to claim 12, wherein said credit card entity is selected from credit card companies, credit card issuers, credit card co-branding partners, credit card affinity card partners, credit card manufacturers, credit card industry consultants, or entities that promote and offer card issuers' cards to the public in exchange for revenues from card issuers.

15. Credit card services according to claim 12, wherein said health reminder is selected by the cardholder or by the credit card entity.

16. Credit card services according to claim 12, wherein said health reminder provides reminders, tips, or suggestions for any health related topic, health related preventive measure, medical check-up, medical exam, or medical procedure.

17. Credit card services according to claim 16, wherein said health reminder is selected from breast or testicular self-exam reminders; skin cancer prevention and screening reminders; mammogram, gynecological exam, prostate exam, vaccination reminders, colorectal exams, bone density screenings, or child immunizations.

18. Credit card services according to claim 16, wherein said health reminder is selected from dental check-ups, vision check-ups, diet and exercise programs, or pet health.

19. Credit card services according to claim 16, wherein said health reminder is gender specific or non-gender specific.

20. Credit card services according to claim 12, wherein said health reminder is provided by mail, fax, e-mail, phone, smartcard reader or other means.

21. Credit card services according to claim 12, wherein said health reminder comprises at least one reminder, tip, or suggestion that is selected from at least one of (a) automatic, general, or non cardholder-specific in nature, (b) customized or tailored to the cardholder relating to at least one aspect of the health reminder information, or (c) reflects the preferences or desires of the cardholder.

22. Credit card services according to claim 12, wherein said health reminder further comprises disclaimers.
